(19) United States
(12) Patent Application Publication
(10) Pub. No.: US 2019/0017491 A1
(43) Pub. Date: Jan. 17, 2019

(54) WIND GATHERING DEVICE

(71) Applicant: HONGMAN CO., LTD., Taipei City (TW)

(72) Inventor: Wei-Jin Li, Taipei City (TW)

(21) Appl. No.: 15/647,601

(22) Filed: Jul. 12, 2017

(51) Int. Cl. F03D 1/04; F03D 1/06

(52) U.S. Cl. CPC F03D 1/04; F05B 2250/5011; F05B 2240/14; F03D 1/06

(57) ABSTRACT

A wind gathering device has a casing and a guiding sleeve, both of which have a trumpet-shaped air inlet and a flange formed annularly around an edge of the air inlet. The guiding sleeve is mounted in the casing and protrudes out of the air inlet of the casing. An annular inlet is annularly formed between the two flanges and extends into a space between an inner wall of the casing and an outer wall of the guiding sleeve. When the wind flows in a direction inclined relative to an axis of the guiding sleeve, the wind may directly enter the annular inlet or hit the two flanges and then shift direction to enter the annular inlet. The wind gathering device can effectively gather wind in various directions to increase the amount of the received wind of the generator.

### BACKGROUND OF THE INVENTION

### 1. Technical Field

The present invention relates to a wind gathering device, especially to a wind gathering device that is installed at a roof for generating wind power.

### 2. Description of Related Art

Wind power is one of the cleanest methods to generate power, and the generator powered by wind, which is also called a wind turbine, can be installed on the roof of a house to supply electricity to other electric devices, such as an air purifier to keep the air clean in the house. However, the amount of the power generated is essentially determined by the amount of the received wind. As a result, how to increase the amount of the received wind is one of the most important problems to be solved in the field of wind power.

To overcome the shortcomings, the present invention provides a wind gathering device to mitigate or obviate the aforementioned problems.

### SUMMARY OF THE INVENTION

The main objective of the present invention is to provide a wind gathering device that is installed on the generator powered by wind to gather the wind in various directions to increase the amount of the received wind.

The wind gathering device has a casing and a guiding sleeve. The casing has a trumpet-shaped air inlet, an air outlet, and a casing flange formed annularly around an edge of the air inlet of the casing. The guiding sleeve is mounted in the casing, protrudes out of the air inlet of the casing, and has a trumpet-shaped air inlet, an air outlet, and a sleeve flange. The air inlet is disposed on an outer side of the air inlet of the casing. The air outlet is disposed in the air inlet of the casing and communicates with an inner space of the casing. The sleeve flange is formed annularly around an edge of the air inlet of the guiding sleeve, and is spaced apart from the casing flange. An annular inlet is annularly formed between the sleeve flange and the casing flange, extends into a space between an inner wall of the casing and an outer wall of the guiding sleeve, and communicates with the inner space of the casing.

When the wind flows toward the guiding sleeve, the wind enters the casing from the air inlet of the guiding sleeve. However, when the wind flows in a direction inclined relative to an axis of the guiding sleeve, the wind may directly enter the annular inlet or hit the casing flange and/or the sleeve flange and then shift direction to enter the annular inlet. The annular inlet is formed between the trumpet-shaped air inlet of the casing and the trumpet-shaped air inlet of the guiding sleeve, thereby guiding the wind to enter the casing via the trumpet-shaped inner wall of the casing and the trumpet-shaped outer wall of the guiding sleeve. In addition, once the wind enters the annular inlet, the casing flange and the sleeve flange also prevent the wind from leaving. As a result, the wind gathering device can effectively gather wind in various directions to increase the amount of the received wind of the generator.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a wind gathering device in accordance with the present invention;

FIG. 2 is a side view of the wind gathering device in FIG. 1;

FIG. 3 is a perspective view of a second embodiment of a wind gathering device in accordance with the present invention;

FIG. 4 is a top view of the wind gathering device in FIG. 3; and

FIG. 5 is a side view in partial section of the wind gathering device in FIG. 3.

### DETAILED DESCRIPTION

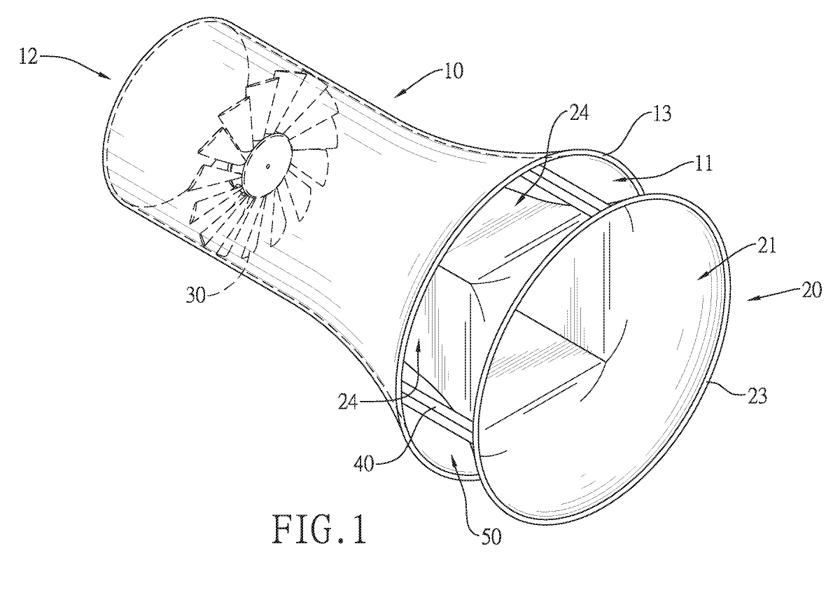

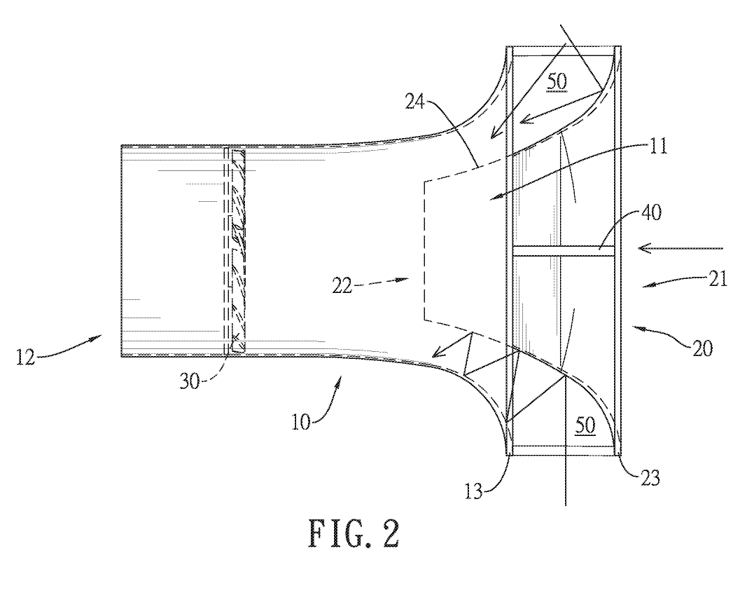

With reference to FIGS. 1 and 2, a first embodiment of a wind gathering device in accordance with the present invention comprises a casing 10, a guiding sleeve 20, and a fan 30.

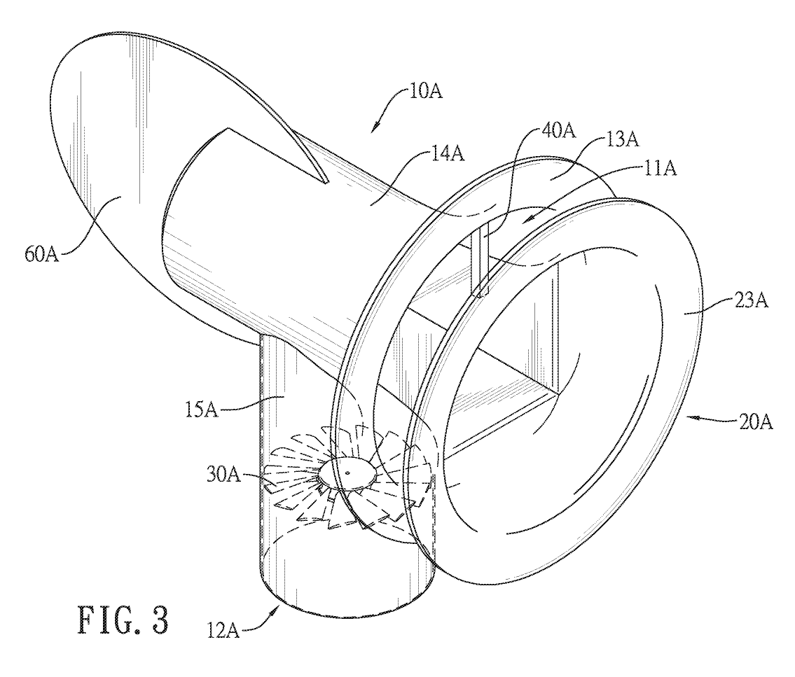

The casing 10 is an elongated tube circular in cross section. However, the casing 10 may be altered in any other shape, such as a tube rectangular in cross section. The casing 10 has an air inlet 11 and an air outlet 12 respectively on both ends of the casing 10. The air inlet 11 is trumpet-shaped, that is, a radius of a surrounding wall of the casing 10 increases in the air inlet 11. The casing 10 further has a casing flange 13 formed annularly around an edge of the air inlet 11. A protruding length of the casing flange 13, 13A may be altered as shown in FIGS. 1 and 3.

In a preferred embodiment, the casing flange 13 is formed transversely relative to an axis defined by the air inlet 11 and the air outlet 12 of the casing 10. That is, a protruding direction of the casing flange 13 is perpendicular to the axis of the casing 10.

The guiding sleeve 20 is an elongated tube circular in cross section and is shorter than the casing 10. The guiding sleeve 20 is mounted in the casing 10, protrudes out of the air inlet 11 of the casing 10, and has an air inlet 21 and an air outlet 22 respectively on the both ends of the casing 10. The air inlet 21 is trumpet-shaped. In a preferred embodiment, a radius of a surrounding wall of the whole guiding sleeve 20 increases from the air outlet 22 to the air inlet 21. The air inlet 21 is disposed on an outer side of the air inlet 11 of the casing 10. The air outlet 22 is disposed in the air inlet 11 of the casing 10 and communicates with an inner space of the casing 10. The guiding sleeve 20 further has a sleeve flange 23 formed annularly around an edge of the air inlet 21, and is spaced apart from the casing flange 13 of the casing 10. A protruding length of the sleeve flange 23, 23A may be altered as shown in FIGS. 1 and 3.

In a preferred embodiment, the sleeve flange 23 is formed transversely relative to an axis defined by the air inlet 21 and the air outlet 22 of the guiding sleeve 20. That is, a protruding direction of the sleeve flange 23 is perpendicular to the axis of the guiding sleeve 20, and the sleeve flange 23 is parallel with the casing flange 13. However, in another preferred embodiment, the sleeve flange 23 and the casing flange 13 may be inclined relative to each other. For example, the sleeve flange 23 may be inclined forward, and the casing flange 13 may be inclined backward.

In a preferred embodiment, multiple connecting bars 40 connect the casing 10 and the guiding sleeve 20. To be specific, the connecting bars 40 are connected between the casing flange 13 and the sleeve flange 23, and are parallel with the axis of the guiding sleeve 20.

In a preferred embodiment, the casing flange 13 and the sleeve flange 23 are the same in protruding lengths. However, the protruding lengths of the two flanges 13, 23 may be different depending on demand.

An annular inlet 50 is annularly formed between the sleeve flange 23 and the casing flange 13, and extends into a space between an inner wall of the casing 10 and an outer wall of the guiding sleeve 20. The annular inlet 50 communicates with the inner space of the casing 10.

The guiding sleeve 20 has multiple recessed parts 24 formed in the outer wall of the guiding sleeve 20, and the recessed parts 24 are curved as shown in FIG. 1. The recessed parts 24 are annularly disposed around the guiding sleeve 20, and thus the guiding sleeve 20 is polygonal in cross section in the recessed parts 24. For example, when an amount of the recessed parts 24 is four, the guiding sleeve 20 is rectangular or square in cross section in the recessed parts 24 shown in FIG. 1. In a preferred embodiment, the guiding sleeve 20 has four recessed parts 24, and the four recessed parts 24 connect to each other. Thus, the four recessed parts 24 shape the guiding sleeve 20 to be substantially rectangular. The recessed parts 24 further enlarge the annular inlet 50 by increasing a distance between the outer wall of the guiding sleeve 20 and the inner wall of the casing 10.

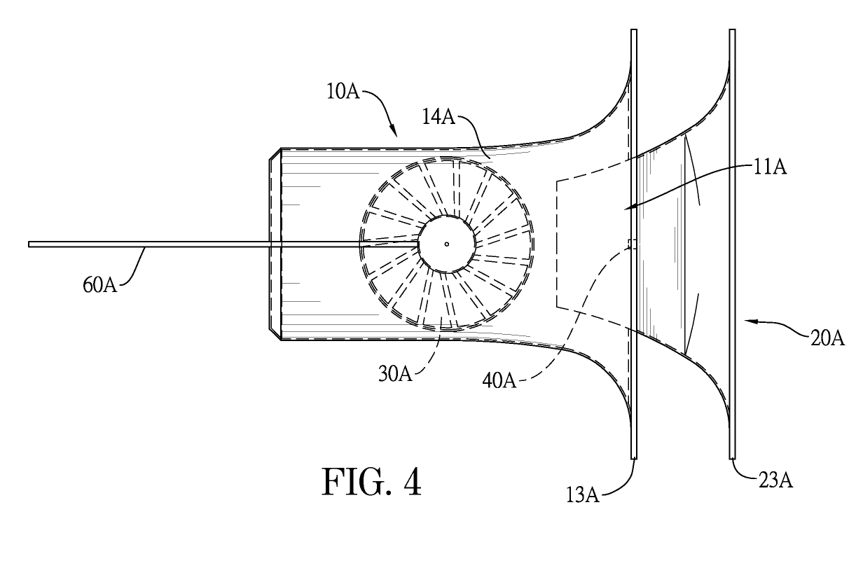

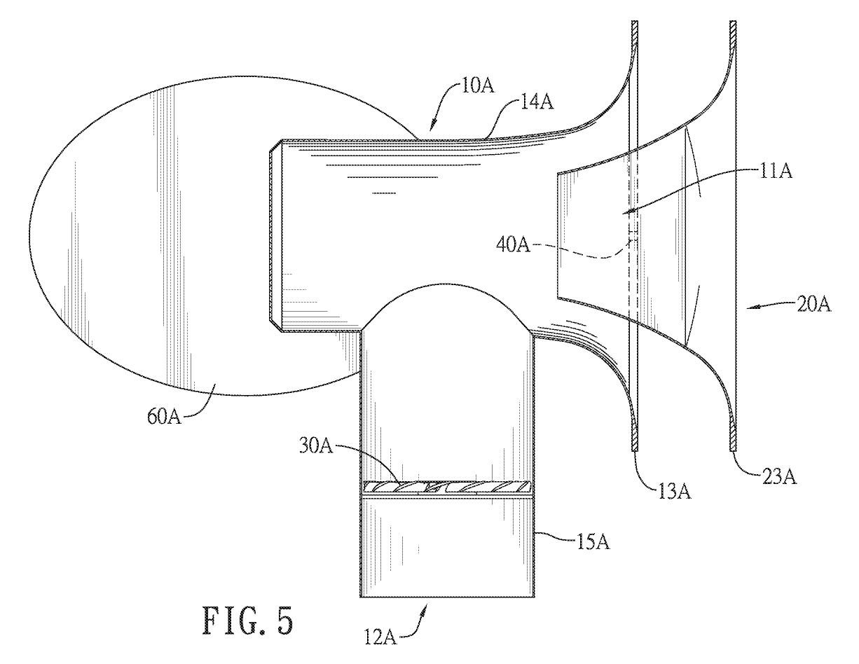

The fan 30 is rotatably mounted in the casing 10 for generating power. To be specific, the fan 30 is a part of the wind-powered generator. In other words, the present invention can be mounted on the generator by connecting the air outlet 12 of the casing 10 to an inlet of the generator. Or, a part of the generator can just be installed in the present invention as shown in FIGS. 1 to 5.

In a preferred embodiment, the fan 30 is mounted in the casing 10, and an axis of the fan 30 is parallel with the axis of the casing 10.

When the first embodiment of the present invention is in use, if the wind flows toward the guiding sleeve 20, the wind enters the casing 10 from the air inlet 21 of the guiding sleeve 20 directly.

However, when the wind flows in a direction inclined relative to the axis of the guiding sleeve 20, the wind may directly enter the annular inlet 50 as shown in FIG. 2, or the wind may hit the casing flange 13 and/or the sleeve flange 23 and then shift direction to enter the annular inlet 50 as shown in FIG. 2.

When the wind enters the annular inlet 50, the trumpet-shaped inner wall of the casing 10 and the trumpet-shaped outer wall of the guiding sleeve 20 guide the wind to flow into the casing 10.

Besides, once the wind enters the annular inlet 50, the casing flange 13 and the sleeve flange 23 also prevent the wind from leaving. The retaining effect may be even better when the protruding distances of the casing flange 13 and the sleeve flange 23 increase.

As a result, the wind gathering device of the present invention can effectively gather wind in various directions to increase the amount of the received wind of the generator.

With reference to FIGS. 3 to 5, a second embodiment of the wind gathering device in accordance with the present invention is substantially similar to the first embodiment mentioned above, but there are three major differences between the two embodiments.

First, the casing 10A comprises an inlet part 14A and an outlet part 15A. Both the inlet part 14A and the outlet part 15A are elongated tubes circular in cross section, and the outlet part 15A is perpendicularly connected to and communicating with the inlet part 14A via one of two ends of the outlet part 15A. The air inlet 11A of the casing 10A is disposed on one of two ends of the inlet part 14A. The air outlet 12A of the casing 10A is disposed on the other end of the outlet part 15A relative to the end connecting the inlet part 14A. The fan 30A is mounted in the outlet part 15A, and an axis of the fan 30A is parallel with a lengthwise direction of the outlet part 15A.

Second, a guiding plate 60A is vertically mounted on the inlet part 14A of the casing 10A, and is disposed on the other end of the inlet part 14A relative to the end forming the air inlet 11A of the casing 10A.

Third, the connecting bars 40A are connected between the inner wall of the casing 10A and the outer wall of the guiding sleeve 20A. The connecting bars 40A are perpendicular to the axis of the guiding sleeve 20A.

When the second embodiment of the present invention is in use, the casing 10A may be rotatably mounted on a roof of a house (or any other kind of building). The guiding plate 60A will rotate the present invention to a suitable angle to receive the largest amount of wind.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A wind gathering device comprising:
a casing having
a trumpet-shaped air inlet;
an air outlet; and
a casing flange formed annularly around an edge of the air inlet of the casing;
a guiding sleeve mounted in the casing, protruding out of the air inlet of the casing, and having
a trumpet-shaped air inlet disposed on an outer side of the air inlet of the casing;
an air outlet disposed in the air inlet of the casing and communicating with an inner space of the casing; and
a sleeve flange formed annularly around an edge of the air inlet of the guiding sleeve, and spaced apart from the casing flange; and
an annular inlet annularly formed between the sleeve flange and the casing flange, extending into a space between an inner wall of the casing and an outer wall of the guiding sleeve, and communicating with the inner space of the casing.

2. The wind gathering device as claimed in claim 1, wherein the sleeve flange is formed transversely relative to an axis defined by the air inlet and the air outlet of the guiding sleeve, and the sleeve flange is parallel with the casing flange.

3. The wind gathering device as claimed in claim 1 further comprising multiple connecting bars connecting the casing and the guiding sleeve.

4. The wind gathering device as claimed in claim 3, wherein the connecting bars are connected between the casing flange and the sleeve flange, and are parallel with an axis defined by the air inlet and the air outlet of the guiding sleeve.

5. The wind gathering device as claimed in claim 3, wherein the connecting bars are connected between the inner wall of the casing and the outer wall of the guiding sleeve, and are perpendicular to an axis defined by the air inlet and the air outlet of the guiding sleeve.

6. The wind gathering device as claimed in claim 1 further comprising a fan rotatably mounted in the casing for generating power.

7. The wind gathering device as claimed in claim 1, wherein the casing is elongated and the air inlet and the air outlet of the casing are respectively on both ends of the casing.

8. The wind gathering device as claimed in claim 6, wherein the casing is elongated and the air inlet and the air outlet of the casing are respectively on both ends of the casing; the fan is mounted in the casing, and an axis of the fan is parallel with an axis defined by the air inlet and the air outlet of the casing.

9. The wind gathering device as claimed in claim 1, wherein the casing further comprises
an inlet part, wherein the air inlet of the casing is disposed on one of two ends of the inlet part; and
an outlet part being elongated, and perpendicularly connected to and communicating with the inlet part via one of two ends of the outlet part, wherein the air outlet of the casing is disposed on the other end of the outlet part.

10. The wind gathering device as claimed in claim 6, wherein the casing further comprises
an inlet part, wherein the air inlet of the casing is disposed on one of two ends of the inlet part; and
an outlet part being elongated, and perpendicularly connected to and communicating with the inlet part via one of two ends of the outlet part, wherein the air outlet of the casing is disposed on the other end the outlet part;
wherein the fan is mounted in the outlet part, and an axis of the fan is parallel with a lengthwise direction of the outlet part.

11. The wind gathering device as claimed in claim 9 further comprising a guiding plate vertically mounted on the inlet part of the casing and disposed on the other end of the inlet part relative to the end forming the air inlet of the casing.

12. The wind gathering device as claimed in claim 1, wherein the guiding sleeve has
multiple recessed parts formed in the outer wall and annularly disposed around the guiding sleeve.
